(19) United States
(12) Patent Application Publication
(10) Pub. No.: US 2008/0281811 A1
(43) Pub. Date: Nov. 13, 2008

(54) Method of Obtaining a Representation of a Text

(75) Inventors: Johannes Henricus Maria Korst, Eindhoven (NL); Gijs Geleijnse, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/093,342

(22) PCT Filed: Nov. 3, 2006
(86) PCT No.: PCT/IB2006/054099

§ 371 Date: May 12, 2008

(30) Foreign Application Priority Data
Nov. 15, 2005 (EP) 05110731.6

(51) Int. Cl. G06F 17/30

(52) U.S. Cl. 707/5; 707/E17.001

(57) ABSTRACT

A method of obtaining a data file (20;22) including a representation of a text, e.g. the lyrics of a song, includes obtaining multiple candidate files (13;25) containing character strings, on the basis of a search query submitted to a server system (5) arranged to permit a search of the contents of at least one server (1-3) to be performed, forming a sub-set (19;35) of the multiple candidate files, and forming the representation of the text from at least one of the candidate files in the sub-set (19;35) only. The method further includes comparing data based on at least some of the character strings in the candidate files, and forming the sub-set (19;35) from candidate files for which the data based on at least some of the character strings satisfies a measure of similarity.

The invention relates to a method of obtaining a data file including a representation of a text, e.g. the lyrics of a song, including

obtaining multiple candidate files containing character strings, on the basis of a search query submitted to a server system arranged to permit a search of the contents of at least one server to be performed,

forming a sub-set of the multiple candidate files, and

forming the representation of the text from at least one of the candidate files in the sub-set only.

The invention also relates to a system for obtaining a data file including a representation of a text, e.g. the lyrics of a song, including

a client for submitting a search query to a server system arranged to permit a search of the contents of at least one server to be performed, and for obtaining multiple candidate files containing character strings in response to the search query,

wherein the system is configured to form a sub-set of the multiple candidate files, and

to form the representation of the text from at least one of the candidate files in the sub-set only.

The invention also relates to a consumer electronics device, comprising a network port and configured for communicating via the network port with a server system arranged to permit a search of the contents of at least one server to be performed.

The invention also relates to a computer program.

Respective examples of such a method, system consumer electronics device and computer program are known from Evillyrics, http://www.evillabs.sk/evillyrics FAQ: “How does it determine where to look for lyrics?”: browse candidates manually, 22 Nov. 2003. EvilLyrics uses general search engines (Google, Alltheweb, Altavista) to look for lyrics. From results returned it picks those which are known lyrics sites. It downloads the first of them and tries to parse it using built-in filters. If the page seems to be fitting, it displays what it considers to be the lyrics in a lyrics pane. Sometimes it returns pages from lyrics sites which are not actual lyrics pages but for example list of lyrics for the whole album. In this case EvilLyrics parses the page and tries to find the link to a corresponding lyrics page. If this fails, it resumes with another hit from result set returned by search engine. If all the results are used and none of them seem to be what it was looking for, an error message is displayed and the lyrics page stays blank.

A problem of the known method is that it is not very suitable for automated access by networked devices. This is due to the fact that such a device must be programmed to adapt it to a particular mark-up in the lyrics page. When the provider of a specialised lyrics page changes the layout, or blocks access, then the device has to be re-programmed.

It is an object of the invention to provide a method, system, consumer electronics device and computer program for obtaining a substantially correct representation of a text on the basis of a search query providing results from various sources.

This object is achieved by the method according to the invention, which is characterised by comparing data based on at least some of the character strings in the candidate files, and forming the sub-set from candidate files for which the data based on at least some of the character strings satisfies a measure of similarity.

Because the method involves obtaining multiple candidate files on the basis of a search query submitted to a server arranged to permit a search of the contents of at least one server, it is advantageously suitable for use in conjunction with a general search engine, so that the method is not limited to one particular database. Because the method involves the comparison of data based on the character strings in the candidate files, it is not limited by tags containing instructions, such as instructions regarding page lay-out as might be provided to a browser programme or similar. The comparison may allow a sorting of the multiple candidate files, so that the method can cope with the fact that multiple candidate files result from the search query. It is suitable for automation since the comparison does not require human intervention. For example, because the correct representation of a text is likely to be the most commonly occurring text within a plurality of candidate files, the method is suited to providing the correct representation of the text.

An embodiment includes

extracting a certain number of different character strings from each of the multiple candidate files to form a characterising set of character strings for each of the multiple candidate files,

comparing a plurality of the characterising sets of character strings to at least one other of the characterising sets of character strings,

wherein candidate files for which the characterising sets of character strings have more than a certain number of character strings in common are added to the sub-set.

The effect of these features is to make the comparison relatively efficient in computational terms. Each comparison of two candidate files is linear in the length of the text formed by all character strings in two candidate files. To extract a certain, i.e. corresponding, number of character strings, say k character strings from a body of n character strings requires O(n) operations. To sort k character strings in an order, e.g. in alphabetical order, requires O(k·logk) operations. To compare k character strings requires O(k) operations. The total number of operations for a comparison is thus O(n+k+k·logk), which compares favourably to comparisons such as the longest common sub-string comparison that require O(n²) operations.

In a first variant of this embodiment the step of extracting a certain number of different character strings from each of the multiple candidate files includes sorting different character strings in at least part of each of the multiple candidate files according to their length and selecting the certain number of different character strings from among the longest.

This makes the sorting that results from the comparison relatively effective, because the longest strings in a text are generally most characteristic of the text. Thus, the longest character strings are very effective in distinguishing the text.

A variant includes selecting character strings from among different character strings with equal length in accordance with a further rule.

Thus, in cases where several different character strings of equal length are found, a criterion is present to select fewer than all of them to form the characterising set. The embodiment helps to meet the requirement that each characterising set be formed by extracting a certain, that is to say fixed, number of character strings from the multiple candidate files.

In an alternative embodiment, the step of extracting a certain number of different character strings from a candidate file includes

determining a frequency of occurrence of at least selected different character strings in the candidate file, and

forming the characterising set from those of the selected different character strings having a highest frequency of occurrence, at least within a selected frequency range.

In general, character strings occurring most frequently define a text quite well, except where the character strings represent common or “stop” words. Thus, the selected different character strings of which the frequency of occurrence is determined can be selected to be absent from a pre-determined list of such common or “stop” words. Alternatively, the selected frequency range can exclude the (higher) frequencies at which such “stop” words tend to occur in any text.

An embodiment of the method includes

obtaining additional candidate files by formulating a search query on the basis of at least one character string common to a plurality of the candidate files for which the data based on at least some of the character strings satisfies the measure of similarity, and

submitting the formulated search query to the server system arranged to permit a search of the contents of at least one server.

This embodiment helps to overcome the negative effects of imperfectly formulated initial search queries. It widens the range of candidate files, and is especially useful where a text is known by various titles.

In an embodiment, the multiple candidate files are obtained on the basis of a search query submitted to a server system arranged to download data stored on the at least one server, to maintain a cache of the downloaded data, to form an index of the cached contents and to compare the search query to the index,

wherein the multiple candidate files are obtained on the basis of data retrieved from the cache maintained by the server system.

This embodiment is especially suited for automated implementation, since it avoids breakdowns that might occur when an attempt is made to download data stored on the at least one server directly from the server after it has been moved but before the index has been updated.

In an embodiment, the sub-set is formed by performing at least once the steps of

(A) selecting at least one initial candidate file for inclusion in a base set,

(B) for each of a further plurality of the multiple candidate files, determining whether the data based on at least some of the character strings satisfies a measure of similarity in comparison to data based on at least some of the character strings in only candidate files previously selected for inclusion in the base set, and

(C) upon determining that the measure of similarity is satisfied, adding the candidate file to the base set.

This embodiment is relatively efficient, since it generally avoids the need to compare data based on at least some of the character strings of each candidate file with data based on at least some of the character strings of each other candidate file. In other words, the number of comparisons is reduced. In effect, a cluster of candidate files is formed.

In a variant of this embodiment, if it has been determined for each of the further plurality of the multiple candidate files whether the data based on at least some of the character strings satisfies the measure of similarity and the base set comprises fewer than a certain number of members, a further base set is formed by selecting at least one initial candidate file for inclusion in a further base set, each selected initial candidate file being different from initial candidate files selected for inclusion in any previously formed base set, and repeating steps (A)-(C) to complete the further base set.

Thus, it is avoided that a sub-optimal selection of the initial candidate files leads to an imperfect result. Several clusters of similar candidate files are formed.

A further enhanced variant includes, upon forming a plurality of base sets and determining that each comprises fewer than the certain number of members, selecting the base set with most members as the sub-set from the candidate files of which to form the representation of the text.

Thus, a result is always arrived at, even if the character strings of the multiple candidate files differ quite widely.

An embodiment includes extracting a certain number of different character strings from each of the multiple candidate files to form a characterising set of character strings for each of the multiple candidate files using a selection criterion,

ranking the characterising sets of character strings according to significance of at least one of the character strings as determined by the selection criterion,

selecting as at least one of the initial candidate files that file for which the characterising set appears highest in the ranking below characterising sets for any candidate files previously selected as initial candidate file.

This embodiment has the advantage of being quite effective in selecting initial candidate files likely to lead to a base set of sufficient size to assume that the members best represent the text. Thus, this embodiment is also relatively efficient, since selection of the best initial candidate files permits the making of fewer comparisons.

In an embodiment, the multiple candidate files are obtained by retrieving multiple source files including the character strings and strings representing control codes for controlling a client, and

the character strings are filtered from the multiple source files in accordance with a set of rules to form the multiple candidate files.

This embodiment is particularly suitable for obtaining a representation of a text using a search engine for searching text files including mark-up codes, such as HTML (Hypertext Markup Language) files, since text is separated from the mark-up codes.

According to another aspect, the system according to the invention is characterised in that the system is further configured to compare data based on at least some of the character strings in the candidate files, and forming the sub-set from candidate files for which the data based on at least some of the character strings satisfies a measure of similarity.

Preferably, the system is configured to execute a method according to the invention.

According to another aspect, the invention provides a consumer electronics device, comprising a network port and configured for communicating via the network port with a server arranged to permit a search of the contents of at least one server, wherein the consumer electronics device comprises a system according to the invention.

According to another aspect, the invention provides a computer program including a set of instructions capable, when incorporated in a machine readable medium, of causing a system having information processing capabilities to perform a method according to the invention.

The present invention also provides for a device for obtaining a data file including a representation of a text, the device being configured

for obtaining multiple candidate files containing character strings,

to form a sub-set of the multiple candidate files, and

to form the representation of the text from at least one of the candidate files in the sub-set only, characterised in that the device is further configured to compare data based on at least some of the character strings in the candidate files, and forming the sub-set from candidate files for which the data based on at least some of the character strings satisfies a measure of similarity.

The invention will now be explained in further detail with reference to the accompanying drawings, in which

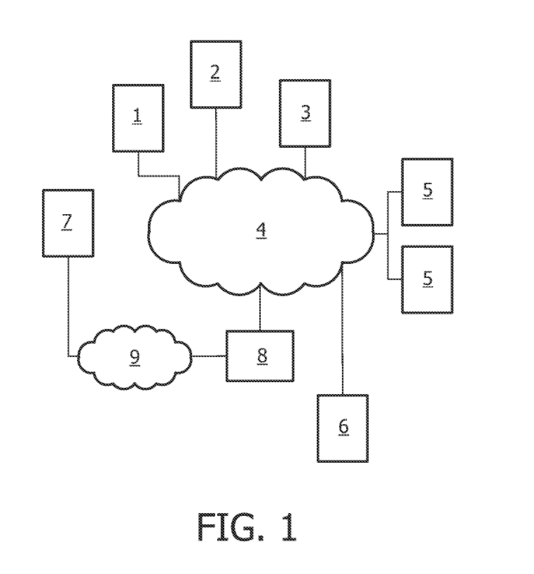

FIG. 1 illustrates schematically an embodiment of a system for application of a method of obtaining a representation of a text,

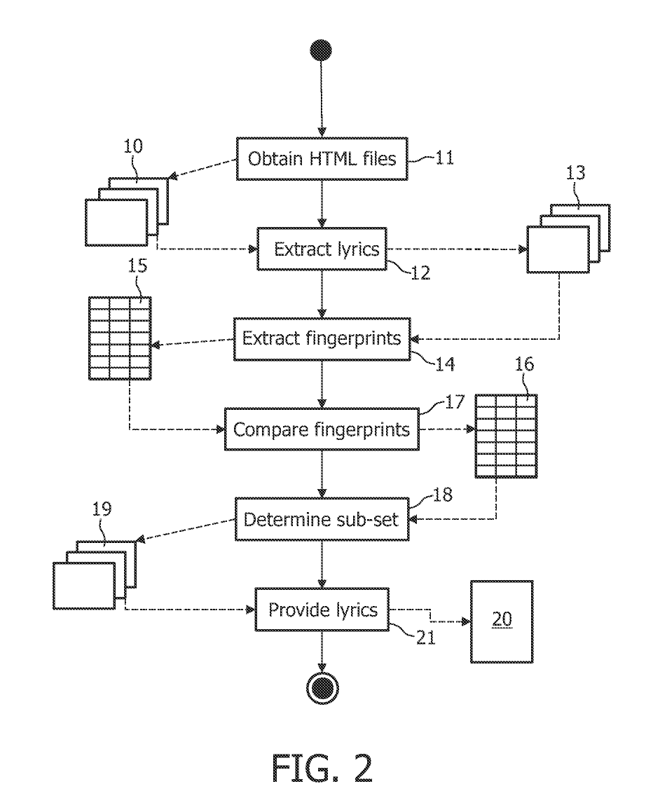

FIG. 2 is a flow chart showing a first example of a method of obtaining a representation of a text,

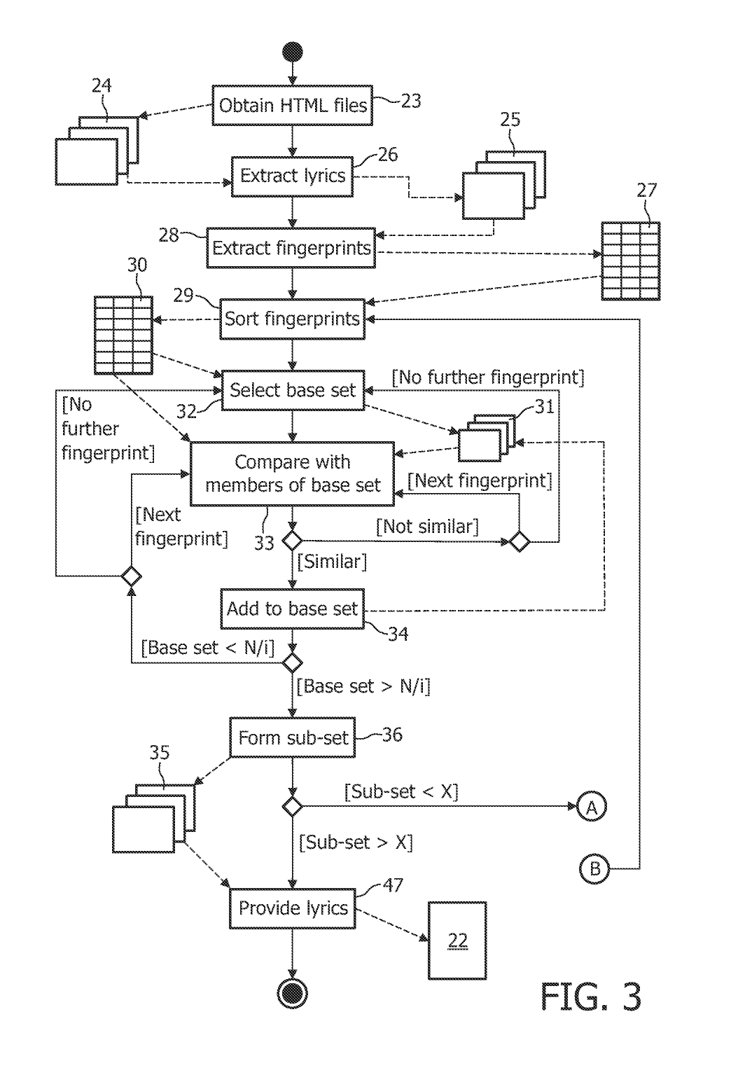

FIG. 3 is a flow chart showing a second example of a method of obtaining a representation of a text, and

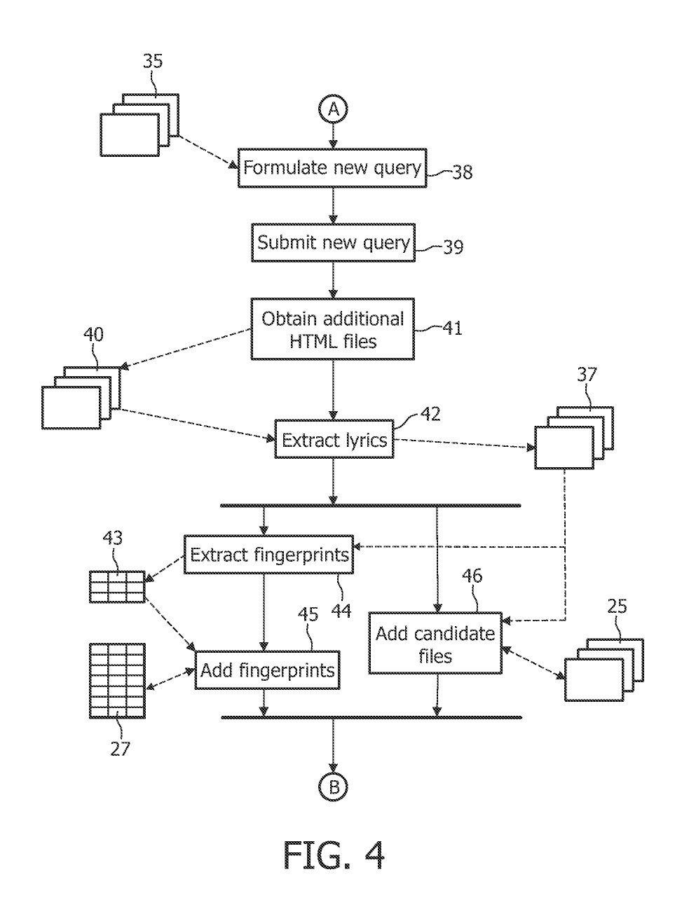

FIG. 4 is a flow chart illustrating additional steps in the method illustrated in FIG. 3.

In the following description, details will be given of methods wherein a text file containing the lyrics of a song is obtained on the basis of a query to a server system implementing a conventional search engine. The methods are, however, equally suited for obtaining representations of other kinds of text of which different versions are hosted on a plurality of servers, e.g. servers storing HTML files. Examples include files containing the text of well-known speeches or books, e.g. the Gettysburg address, Bible texts, etc.

In FIG. 1, first, second and third web servers 1-3 are connected to a wide area network (WAN) 4, e.g. the Internet. Each of the web servers 1-3 hosts a plurality of HTML files including character strings representing text and strings representing control codes for controlling the presentation of the text by a browser, i.e. a software application that enables a user to display and interact with the HTML documents hosted by the web servers 1-3. Of course, the number of web servers 1-3 is limited to three in FIG. 1 for simplicity, there being many more servers in a practical implementation.

A server system 5 is arranged to permit a search of the contents of files hosted on the web servers 1-3. The server system 5 implements a search engine. The search engine is of a type known per se, for example Google, Yahoo! search, MSN search etc. In alternative embodiments, the server system 5 is of a type submitting a search query to several of such search engines and amalgamating the results. The invention is not limited to HTML documents, but may also use the results of a search query submitted to a search engine arranged to search for other types of content including RSS feeds (a type of eXtensible Markup Language format for web syndication) and .PDF files (Portable Document Format). Also, although the web servers 1-3 operate in accordance with the HTTP protocol, variants of the methods presented below make use of the results provided by search engines for searching FTP servers or search engines for the Gopher protocol.

Web search engines, such as those of which use is made in the situation depicted in FIG. 1, function by retrieving files from the web servers 1-3. These files are retrieved by a spider or crawler. The retrieved files are first converted to HTML, if they are in another format, and subsequently cached. The contents of the cached HTML files are indexed by analysing their contents. Data resulting from the indexing process is stored in an index database. When a search query is submitted to the server system 5, this search query is compared against data in the index database to return a result including links to the locations at which the indexed files were stored when retrieved by the crawler.

Search queries are submitted to the server system 5 in the form of regular expressions. A regular expression is a string that describes or matches a set of strings according to certain syntax rules. It is an expression that describes a set of strings, and is sometimes known as a pattern.

The system illustrated in FIG. 1 includes a lyrics server 6. The system further includes a mobile content player 7, for example a cellular telephone with a decoder application for decoding compressed music files, such as files in the MP3, WMA or similar format. The mobile content player 7 is connected to the WAN 4 via a gateway 8 and cellular radio communications network 9. The lyrics server 6 is arranged to execute a method as will be described below, in order to provide the mobile content player 7 with a file comprising a representation of the lyrics of a song.

The mobile content player 7 sends a message to the lyrics server 6 containing a request for a lyrics file. The request comprises data associated with the song of which the lyrics are requested. For example, the mobile content player 7 may retrieve one or more identification tags from the file containing the compressed audio data. Such identification tags generally include the name of the artist and the name of the track.

The lyrics server 6 receives the request and retrieves the data identifying the requested song from the request. This data is used to formulate a search query, a regular expression, which is submitted to the server system 5 via the WAN 4. A wrapper program is used to obtain search results from the server system 5 comprising the search engine. The wrapper program extracts data from the web-site provided as an interface to the search engine by the server system 5. The wrapper program uses the coherent structure of the web-site provided by the server system 5 to retrieve URLs (Uniform Resource Locators) of the locations at which files are stored that match the search query. The lyrics server 6 preferably uses an API (Application Program Interface) provided by the search engine to retrieve the contents of the URLs indicated as search results.

In an embodiment, the API provides a method referred to as a cache request, with which a URL is submitted to the search engine's API service. The latter returns the contents of the URL as cached by the server system 5 when the search engine's crawler last visited the URL. The effect is that the lyrics server 5 need not handle error message that might occur if it tried to retrieve the contents from one of the web servers 1-3 after the contents had been moved. Preferably, the cache maintained by the server system 5 is in the form of only HTML files. This obviates the need for conversion by the lyrics server 6.

In one embodiment, illustrated in FIG. 2, the lyrics server 6 retrieves a set 10 of HTML files by submitting a series of cache requests to the server system 5 (step 11).

In a subsequent step 12 the lyrics server 6 generates a set 13 of candidate files. It is noted that, as used herein, the term file means a sequence of bits stored as a single unit. The units need not correspond to the files maintained by the file system in use on the lyrics server 6. Nevertheless, in a simple, and for this reason preferred, implementation, the set 13 of candidate files is formed by a set of plain text files. Each text file is based on a corresponding one of the set 10 of HTML files.

When executing the step 12 of extracting lyrics from the set 10 of HTML files, the lyrics server analyses the character strings and strings representing control codes for controlling a browser client. The character strings are filtered out to form the set 13 of candidate files, each based on a respective one of the set 10 of HTML files. In this process, HTML tags, advertisements and surrounding text are discarded or replaced by the corresponding character code in a plain text file. For example, the <br> tag is replaced by the new-line character. The process of extracting lyrics to form the set 13 of candidate files is carried out on the basis of structural characteristics of lyrics so as to identify the lyrics within the total contents of an HTML document. Thus, a set of rules is used to form the set 13 of candidate files.

Examples of rules include:
The lyrics of a song are composed out of blocks of text, separated by blank lines. There are typically one to ten blocks. Each block typically consists of one to ten lines, and each line typically consists of three to sixty characters, of which at least half are letters.
The lines of the lyrics are explicitly broken by a <BR> tag and do not contain other HTML tags.
The lyrics are usually preceded by a line containing at least the song title and sometimes the artists' names, the album name, or the term “Lyrics”. This line is usually in a different font from that of the lyrics.

In a subsequent step 14 a certain number k of different character strings are extracted from each of the multiple candidate files in the set 13 to form a characterising set of character strings for each of the multiple candidate files. These characterising sets are referred to as fingerprints herein, and shown as a table 15 of fingerprints in FIG. 2. Although the term fingerprints is used herein, it should be noted that these are not fingerprints in the conventional sense, as a fingerprint need not be unique for the candidate file for which, and on the basis of which, it is generated. The number k is the same for each of the candidate files in the set 13. In this embodiment it is a pre-determined number. It may be a variable, dependent on the number of candidate files in the set 13.

One of a number of alternative possible implementations of the step 14 of extracting fingerprints is employed.

In a first embodiment, different character strings in at least part of each of the multiple candidate files in the set 13 are sorted according to their length and the k character strings are selected from among the longest. In principle, the k longest are selected. However, there may be one or more rules prohibiting the selection of certain character strings. These might include character strings corresponding to words in the title, for example. In one variant, each of the set 13 of candidate files is analysed in its entirety. In another variant only a part of each candidate file is analysed to determined the k longest character strings. If the analysis reveals that there are several different character strings of equal length, then a sufficient number of them are chosen in accordance with a further rule, so as to arrive at a set of k character strings. For example, those of the character strings with equal length appearing with the highest frequency in the part of the candidate file of which the character strings have been sorted according to their length may be chosen to complete the fingerprint.

In a second embodiment, the lyrics server 6 determines a frequency of occurrence of at least selected different character strings in a candidate file. It forms the fingerprint from those of the selected different character strings having a highest frequency of occurrence, at least within a selected frequency range. To prevent the selection of common stop words, such as “the”, “a”, conjugations of the verbs “to be” and “to “have”, etc., these can be excluded from selection. Common stop words in the domain of application can be excluded as well. For instance, when applied to lyrics, the combination of the words “love” and “you” can be excluded. Alternatively, knowledge of the usual frequency of occurrence of the stop words in texts in the language of the lyrics under consideration can be used to limit the frequency range. The language of the lyrics may be made known to the lyrics server 6 via the request submitted by the mobile content player 7.

Regardless of the way in which the fingerprints in the table 15 of fingerprints are obtained, a table 16 of matching fingerprints is subsequently formed (step 17). In this step 17, the fingerprints based on (i.e. corresponding to) at least some of the character strings in the candidate files are each compared to at least one other of the fingerprints to determine whether they satisfy a measure of similarity. In the embodiment of FIG. 2, in contrast to that of FIG. 3, each fingerprint is compared to each other fingerprint. If b of the k character strings in the fingerprint match, then the measure of similarity is satisfied. In one variant, the group of fingerprints satisfying the similarity measure and having most members is selected to form the table 16 of matching fingerprints.

Subsequently (step 18) the candidate files associated with the fingerprints in the table 16 of matching fingerprints are determined. These form a sub-set 19 of candidate files on the basis of which a single lyrics file 20 is formed (step 21).

The step 21 can be implemented in any of a number of ways. One simple implementation is the choice of the lyrics file 20 at random from the sub-set 19. In another variant, further analysis is applied to the sub-set 19 to reduce its size even further. For example, the method of FIG. 2 may be repeated with fingerprints of m character strings, m>k. In another variant, the contents of the candidate files are partitioned into fragments. In this variant, the lyrics file 20 is formed as an ordered sequence of fragments, at least one of which is constructed on the basis of a cluster of fragments from the candidate files in the sub-set 19 satisfying a certain criterion. Thus, the contents of the lyrics file 20 are obtained from a plurality of the candidate files in the sub-set 19. This embodiment may use a technique set out more fully in co-pending patent application of the applicant, entitled “Method, system and device for obtaining a representation of a text”, having the same EP priority date as the present application and published as. The lyrics file 20 is provided to the mobile content player 7 via the WAN 4, gateway 8 and cellular radio communications network 9.

A second method of obtaining a lyrics file 22 is illustrated in FIGS. 3 and 4. A first step 23 corresponds to the first step 11 in the method of FIG. 2, and is used to obtain a set 24 of HTML files. Any of the variants discussed above with regard to the first step 11 of the method illustrated in FIG. 2 is usable to implement the first step 23 shown in FIG. 3.

A set 25 of candidate files is created (step 26) in exactly the same way as in the corresponding step 12 in the method illustrated in FIG. 2. A first table 27 of fingerprints is created (step 28) as in the corresponding step 14 in the method of FIG. 2.

In the variant of FIG. 3, a clustering algorithm is used, in order to match fingerprints relatively efficiently. In a first step 29, an ordered table 30 of fingerprints is created by ranking the fingerprints in the first table 27 according to significance of at least one of the character strings in each fingerprint, as determined by the criterion for selecting the character strings for inclusion in the fingerprint. Thus, where the character strings in the candidate files of the set 25 have been sorted according to their length in order to select from them the longest k character strings, the fingerprints in the first table 27 are now sorted according to the length of the character strings comprised in them. In one variant the length of the longest character string in each fingerprint is used to rank the fingerprints. In another variant, the length of the shortest character string is taken. In another variant, the average length of the character strings in each fingerprint is determined and used to rank the fingerprints. In yet another variant, the sum of the lengths of the respective character strings in the fingerprints is used. In an advantageous variant, the ordering is carried out by first comparing the most significant character string of the fingerprints. When the measures associated therewith are equal (the lengths of the longest character strings in two fingerprints are equal), the next most significant character strings in two fingerprints are compared, etc.

Where, in the step 28 of extracting the fingerprints, the frequency of appearance of selected character strings has been used, the ordered table 30 ranks the fingerprints according to the frequency associated with one or several of the character strings in the respective fingerprints. In one variant, the fingerprints are ranked according to the sum of the frequencies of appearance of the character strings forming the respective fingerprints.

A base set 31 of candidate files is now selected (step 32). The base set 31 starts with at least one candidate file, for which the fingerprint appears at the top of the ordered table 30 of fingerprints. The effect of the sorting operation (step 29) is that the fingerprints appearing at the top of the ordered table 30 are likely to be fingerprints for complete lyrics, whereas those near the bottom are likely to be fingerprints for incomplete lyrics. Thus, the clustering starts with the candidate files most likely to represent the “correct” lyrics.

In the preferred variant, the top of the ordered table 30 is searched for two fingerprints having at least C character strings in common. The associated candidate files are assigned to the base set 31 as initial candidate files. Because the initial candidate files are selected from those for which the fingerprints appear at the top of the ordered table 30, they are most likely to represent a complete version of the lyrics.

In a next step 33 a further fingerprint is compared to the fingerprints for only those candidate files that have already been added to the base set 31. If the further fingerprint does not satisfy the similarity criterion, a next one of the fingerprints in the ordered table 30 is selected. If the fingerprint does satisfy the similarity criterion, the associated candidate file is added to the base set (step 34).

Assuming that there are N candidate files in the set 25, the steps 33,34 to add candidate files to the base set 31 are repeated until the base set is large enough. The criterion for this is that it comprise more than N/i members, with 2≦i≦N. If the criterion is not satisfied after all fingerprints have been compared, then a different pair of initial candidate files is selected for inclusion in at least one further base set. This is done in such a way that none of the different pair has been selected as initial candidate file for any of the previously formed base sets.

If the first or any of the further base sets satisfies the criterion of including more than N/i members, then a sub-set 35 if candidate files is formed (step 36), which is constituted by the base set 31 satisfying the criterion of having a sufficient number of members.

If, upon forming a plurality of base sets and determining that each comprises fewer than N/i members, it is found that no more base sets can or should be formed, the largest of the previously formed plurality of base sets is used to constitute the sub-set 35 of candidate files. The number of iterations of the steps 32-34 to form a base set may, for example, be limited to a pre-determined number. Alternatively, the lyrics server 6 may determine that each of the candidate files in the set 25 has been selected as initial candidate files for a base set 31.

In one embodiment, the lyrics file 22 is now formed on the basis of the sub-set 35 of candidate files, using a method outlined above with regard to the corresponding step 21 in the method of FIG. 2.

In the embodiment illustrated in FIGS. 3 and 4, the lyrics server 6 expands the sub-set 35 of candidate files if it is determined that it comprises fewer than X members. This is illustrated schematically in FIG. 4. The lyrics server 6 obtains a set 37 of additional candidate files by formulating (step 38) at least one search query on the basis of at least one character string common to a plurality of the candidate files in the sub-set 35 of candidate files previously obtained.

The search query is a regular expression. It is submitted (step 39) to the search engine hosted by the server system 5. In the manner outlined previously with regard to the similar steps 11,23 illustrated in FIGS. 2 and 3, a set 40 of additional HTML files is obtained (step 41).

The set 37 of additional candidate files is obtained (step 42) in the same manner as in the corresponding steps 12,26 illustrated in FIGS. 2 and 3 and described above with regard to the step 12 shown in FIG. 2.

Subsequently, additional fingerprints 43 are extracted (step 44) from the additional candidate files in the set 37. The additional fingerprints 43 are added to the first table 27 of fingerprints (step 45). The additional candidate files 37 are added to the set 25 of candidate files (step 46). Then, the steps 29,32-34,36 are repeated to form a new sub-set 35 of candidate files, on the basis of which the lyrics file 22 is formed in a last step 47 of the method illustrated in FIGS. 3 and 4. This last step 47 corresponds to the last step 21 in the method illustrated in FIG. 2. Any of the implementations of that step 21 can be used in the last step 47 of the method illustrated in FIGS. 3 and 4.

The effect of expanding the sub-set 35 of candidate files by formulating a new search query to obtain the set 40 of additional HTML files, is that the lyrics file 22 is based on more candidate files. This makes it more likely that the contents of the lyrics file 22 are correct. Another effect is that there is less need for user intervention, because the method automatically expands the set 25 of candidate files by analysing the contents of the sub-set 35 of candidate files obtained when the first steps 23,26,28-29,32-34,36 are performed automatically by a data processing system such as the lyrics server 6. Thus, the method is arranged to permit automated execution, in such a manner that the data processing system performing the method is independent from any one lyrics server or search engine. Instead, the most correct version of a text is formed using multiple files purporting to contain a correct version of the text and obtained from respective servers.

It should be noted that the above-mentioned embodiments illustrate, rather than limit, the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

For instance, although an embodiment using a mobile content player 7 and a lyrics server 6 has been described, an alternative embodiment includes only a program on a single computer with a network connection, for example a personal computer. Alternatively, the mobile content player 7 may perform the entire method leading to a text file, or the entire method may be performed by the server system 5 that also comprises the search engine for searching the Internet.

1. Method of obtaining a data file (20;22) including a representation of a text, e.g. the lyrics of a song, including
obtaining multiple candidate files (13;25) containing character strings, on the basis of a search query submitted to a server system (5) arranged to permit a search of the contents of at least one server (1-3) to be performed,
forming a sub-set (19;35) of the multiple candidate files, and
forming the representation of the text from at least one of the candidate files in the sub-set (19;35) only, characterised by comparing data based on at least some of the character strings in the candidate files, and forming the sub-set (19;35) from candidate files for which the data based on at least some of the character strings satisfies a measure of similarity.

2. Method according to claim 1, including
extracting a certain number of different character strings from each of the multiple candidate files (13;25) to form a characterising set of character strings for each of the multiple candidate files (13;25),
comparing a plurality of the characterising sets of character strings to at least one other of the characterising sets of character strings,
wherein candidate files for which the characterising sets of character strings have more than a certain number of character strings in common are added to the sub-set (19;35).

3. Method according to claim 2, wherein the step of extracting a certain number of different character strings from each of the multiple candidate files (13;25) includes sorting different character strings in at least part of each of the multiple candidate files (13;25) according to their length and selecting the certain number of different character strings from among the longest.

4. Method according to claim 3, including selecting character strings from among different character strings with equal length in accordance with a further rule.

5. Method according to claim 2, wherein the step (14;28) of extracting a certain number of different character strings from a candidate file includes
determining a frequency of occurrence of at least selected different character strings in the candidate file, and
forming the characterising set from those of the selected different character strings having a highest frequency of occurrence, at least within a selected frequency range.

6. Method according to claim 1, including
obtaining additional candidate files (37) by formulating a search query on the basis of at least one character string common to a plurality of the candidate files for which the data based on at least some of the character strings satisfies the measure of similarity, and
submitting the formulated search query to the server system (5) arranged to permit a search of the contents of at least one server (1-3).

7. Method according to claim 1, wherein the multiple candidate files (13;25) are obtained on the basis of a search query submitted to a server system (5) arranged to download data stored on the at least one server (1-3), to maintain a cache of the downloaded data, to form an index of the cached contents and to compare the search query to the index,
wherein the multiple candidate files (13;25) are obtained on the basis of data retrieved from the cache maintained by the server system (5).

8. Method according to claim 1, wherein the sub-set (35) is formed by performing at least once the steps of
(A) selecting at least one initial candidate file for inclusion in a base set (31),
(B) for each of a further plurality of the multiple candidate files, determining whether the data based on at least some of the character strings satisfies a measure of similarity in comparison to data based on at least some of the character strings in only candidate files previously selected for inclusion in the base set (31), and
(C) upon determining that the measure of similarity is satisfied, adding the candidate file to the base set (31).

9. Method according to claim 8, wherein, if it has been determined for each of the further plurality of the multiple candidate files whether the data based on at least some of the character strings satisfies the measure of similarity and the base (31) set comprises fewer than a certain number of members, a further base set (31) is formed by selecting at least one initial candidate file for inclusion in a further base set (31), each selected initial candidate file being different from initial candidate files selected for inclusion in any previously formed base set, and repeating steps (A)-(C) to complete the further base set.

10. Method according to claim 9, including, upon forming a plurality of base sets (31) and determining that each comprises fewer than the certain number of members, selecting the base set with most members as the sub-set (35) from the candidate files of which to form the representation of the text.

11. Method according to claim 8, including
extracting a certain number of different character strings from each of the multiple candidate files (13;25) to form a characterising set of character strings for each of the multiple candidate files using a selection criterion,
ranking the characterising sets of character strings according to significance of at least one of the character strings as determined by the selection criterion,
selecting as at least one of the initial candidate files that file for which the characterising set appears highest in the ranking below characterising sets for any candidate files previously selected as initial candidate file.

12. Method according to claim 1, wherein the multiple candidate files are obtained by retrieving multiple source files (10;24) including the character strings and strings representing control codes for controlling a client, and
wherein the character strings are filtered from the multiple source files (10;24) in accordance with a set of rules to form the multiple candidate files.

13. System for obtaining a data file (20;22) including a representation of a text, e.g. the lyrics of a song, including
a client (6) for submitting a search query to a server system (5) arranged to permit a search of the contents of at least one server (1-3) to be performed, and for obtaining multiple candidate files (13;25) containing character strings in response to the search query,
wherein the system is configured to form a sub-set (19;35) of the multiple candidate files, and
to form the representation of the text from at least one of the candidate files in the sub-set (19;35) only, characterised in that the system is further configured to compare data based on at least some of the character strings in the candidate files, and forming the sub-set (19;35) from candidate files for which the data based on at least some of the character strings satisfies a measure of similarity.

14. System according to claim 13, configured to execute a method according to claim 1.

15. Consumer electronics device, comprising a network port and configured for communicating via the network port with a server system (5) arranged to permit a search of the contents of at least one server (1-3) to be performed, wherein the consumer electronics device comprises a system according to claim 13.

16. Computer program including a set of instructions capable, when incorporated in a machine readable medium, of causing a system having information processing capabilities to perform a method according to claim 1.

17. A device for obtaining a data file including a representation of a text, the device being configured
for obtaining multiple candidate files containing character strings,
to form a sub-set of the multiple candidate files, and
to form the representation of the text from at least one of the candidate files in the sub-set only, characterised in that the device is further configured to compare data based on at least some of the character strings in the candidate files, and forming the sub-set from candidate files for which the data based on at least some of the character strings satisfies a measure of similarity.
